(19) United States
(12) Patent Application Publication
(10) Pub. No.: US 2002/0184287 A1
(43) Pub. Date: Dec. 5, 2002

(54) Method and device for executing network-centric program code with reduced memory

(76) Inventor: Patrick Nunally, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/872,762

(22) Filed: Jun. 1, 2001

(51) Int. Cl. G06F 17/00

(52) U.S. Cl. 709/1

(57) ABSTRACT

A virtual machine instruction processor couples a small, localized embedded processor with a primitive state machine, which acts as a boot/interface function. The seed processor also includes a local random access memory (RAM) for buffering of data and execution and a read only memory (ROM) for storing the TCP/IP stack. The seed processor is connected to a remote virtual machine through communication controllers over a network such that the virtual machine is not co-located with the virtual machine instruction processor. The virtual machine instruction processor executes software local to the instruction processor without a co-located virtual machine.

### BACKGROUND OF THE INVENTION

1. Field of the Invention

The invention relates generally to computer systems and, in particular, to embedded processors which implement virtual machine functionality.

2. Description of the Related Art

The Java™ programming language has emerged as the programming language of choice for the Internet since many large hardware and software companies have licensed it. This language and its environment are designed to solve a number of problems in modern programming practice. The Java programming language is based on an extensive library of routines for coping easily with TCP/IP (Transmission Control Protocol based on Internet Protocol), HTTP (Hypertext Transfer Protocol) and FTP (File Transfer Protocol).

One concept of the Java programming language is the use of virtual machines. As used herein, a virtual machine is a software emulation of a real machine. A virtual machine, like a real computing machine, has a known instruction set. The Java virtual machine instruction set is composed of byte-codes. A byte-code is either a byte-sized instruction or a byte-sized operand. Java defines a byte as 8 bits. Thus, there is a limit of 255 unique byte-codes. When a Java source code is compiled, the Java compiler converts program statements into byte-codes. The compiler creates a class file to contain the output of the byte-codes.

When the Java runtime system runs a Java program, the data contained in the class files is loaded into memory and a Java byte-code interpreter is started. The Java interpreter reads each successive byte-code and passes the associated instruction and operands to the Java virtual machine. The byte-code interpreter performs a series of steps. The first step is to fetch the opcode. The second step is to find the number of operands and fetch the operands. The next step is to execute the action based on the opcode. Next, a program counter (PC) is incremented to PC+1+the number of arguments for the particular opcode executed. The steps are repeated until all the instructions are executed.

Each virtual machine instruction defines a specific operation that is to be performed. The virtual machine need not understand the computer language that is used to generate virtual machine instructions, only a particular file format for virtual machine instructions needs to be understood. The Java virtual machine then implements the operations contained in the byte-code instructions on the processor of the host machine.

While Java and like mechanisms have proven useful in their applicability as a pervasive access and control means, the use has been limited in some applications by cost, size, power and forward compatibility requirements. In some applications, the expense of including memory sufficient to store a Java virtual machine is prohibitive. These applications include, for example, Internet chips for network appliances, control of on-chip processors, other telecommunications integrated circuits, or other low-power, low-cost applications such as embedded processors and portable devices.

Another problem is that virtual machines on different platforms today simply do not behave similarly. This makes debugging a serious problem for Java deployment in a heterogeneous environment. Moreover, the Java language is not static and is prone to execution errors associated with new virtual machine instructions and the wide variety of virtual machines, which are in use.

Thus, there is a need to centralize the virtual machine, thus allowing a vast deployment of instruction processors in long-term applications with no fear of future compatibility issues. There is also a need to provide greater longevity to potentially large infrastructures of fielded Java based systems by providing an instruction processor that can be updated continuously simply by providing the updates to a remote virtual machine, thus allowing the entire installed base to execute new commands, translations and functions. There is also a need to provide an enhanced level of security to systems beyond data encryption and secure shells, by using a secure channel to a remote virtual machine processor to enhance the security of Java by controlling not only the contents of the virtual machine but the access sequence at execution time.

In view of these considerations, a system having a single or multiple instruction processors embedded into various ASICs so as to enable execution of instructions from a remote virtual machine presents an attractive price for performance characteristics, as compared with alternative virtual machine execution environments, including software interpreters and Just-In-Time compilers.

### SUMMARY OF THE INVENTION

One embodiment of the invention is directed to a virtual machine instruction processor. The virtual machine instruction processor includes a local memory cache for storing executable data for commands, a local processor for executing virtual machine instructions, wherein the local processor is configured to search the local memory cache for executable data when a command is received and transmit a command request to a remote virtual machine if the executable data for the command are not found in the local memory cache. The virtual machine instruction processor also includes a controller for controlling the interface of data between the local processor, the local memory cache and the remote virtual machine.

Another embodiment of the invention is a system for communicating instructions over a network from a remote virtual machine to a host processor with a virtual machine instruction processor. The system includes a network, a remote device including a communication controller connected to the network and a virtual machine. The system also includes a host device not co-located with the remote device including a host processor, a communication controller connected to the network for communicating with the remote device, and a virtual machine instruction processor connected to the host processor. The virtual machine instruction processor includes a local memory cache for storing executable data for commands, a local processor for executing virtual machine instructions, wherein the local processor is configured to search the local memory cache for executable data when a command is received and transmit a command request to a remote virtual machine if the executable data for the command are not found in the local memory cache. The virtual machine instruction processor also includes a controller for controlling the interface of data between the local processor, the local memory cache and the remote virtual machine.

A further embodiment is a host device containing a virtual machine instruction processor for executing instructions received from a remote virtual machine. The host device includes a host processor, a communication controller connected to the network for communicating with the remote device, and a virtual machine instruction processor connected to the host processor. The virtual machine instruction processor includes a local memory cache for storing executable data for commands, a local processor for executing virtual machine instructions, wherein the local processor is configured to search the local memory cache for executable data when a command is received and transmit a command request to a remote virtual machine if the executable data for the command are not found in the local memory cache. The virtual machine instruction processor also includes a controller for controlling the interface of data between the local processor, the local memory cache and the remote virtual machine.

An additional embodiment is a server for communicating instructions over a network from a virtual machine to a host processor with a virtual machine instruction processor. The server includes a communication controller connected to a network and a virtual machine configured to receive virtual language commands from a remote virtual machine instruction processor, and identify byte-codes to the remote virtual machine through the communication controller.

Still another embodiment includes a method of communicating commands over a network from a remote virtual machine to a host processor using a virtual machine instruction processor. The method includes receiving a command from the host processor and determining whether the command is executable based on data stored in local memory accessible by the virtual machine instruction processor, transmitting the command from the virtual machine instruction processor to the remote virtual machine if data to execute the command is not stored in the local memory. The method further includes executing the remote virtual machine to obtain executable data required to execute the command request. The method further includes returning the executable data to the virtual machine instruction processor from the remote virtual machine. The method further includes executing the executable data by the virtual machine instruction processor.

### BRIEF DESCRIPTION OF THE DRAWINGS

These and other objects and features of the present invention will become more fully apparent from the following description and appended claims taken in conjunction with the following drawings, where like reference numbers indicate identical or functionally similar elements. Additionally, the left-most digit(s) of a reference number identifies the drawing in which the reference number first appears.

FIG. 1 is a block diagram of a seed processor in a local host connected to a virtual machine at a remote host through a network.

FIG. 2 is a flowchart of an embodiment of a boot routine process of the seed processor of FIG. 1.

FIG. 3 is a flowchart of a process of executing opcode at the host using the seed processor of FIG. 1.

FIG. 4 is a flowchart of a process of identifying byte-codes and classes and returning commands to the seed processor of FIG. 1.

FIG. 5 is a flowchart of a process of resetting a session of a virtual machine.

FIG. 6 is a flowchart of a process of reinitiating the real time operating system.

FIG. 7 is a flowchart of a process of analyzing the request history of a seed processor of FIG. 1.

### DETAILED DESCRIPTION OF THE INVENTION

The following presents a detailed description of embodiments of the invention. However, the invention can be embodied in a multitude of different ways as defined and covered by the claims. The invention is more general than the embodiments that are explicitly described, and is not limited by the specific embodiments but rather is defined by the appended claims.

System Description Overview

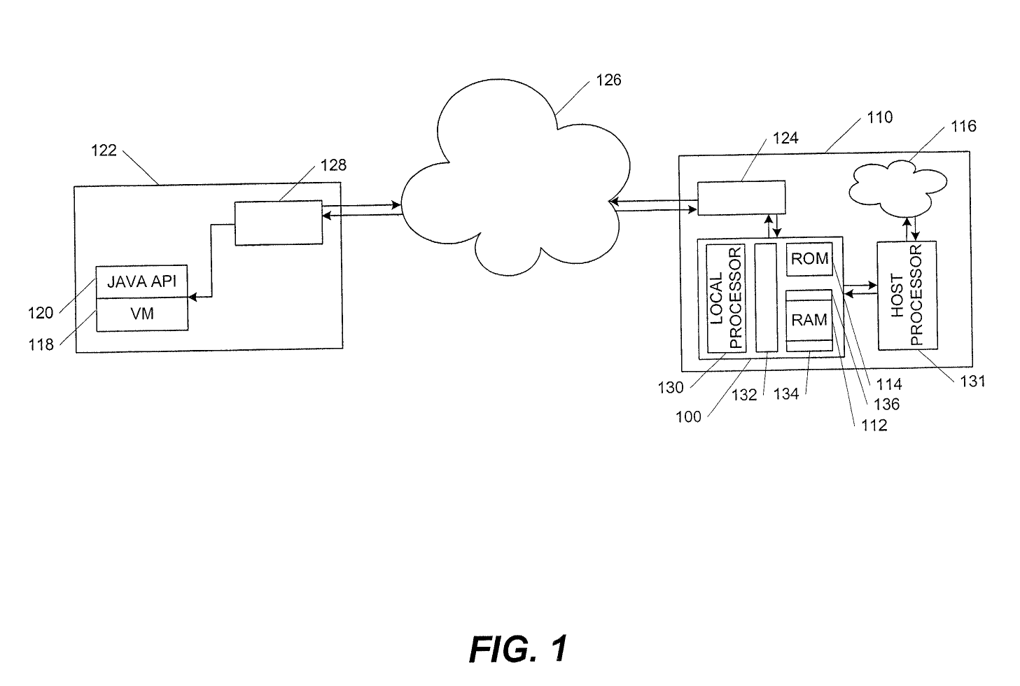

FIG. 1 shows a block diagram of an embodiment of a seed processor 100 supported by a host 110. The seed processor 100 is a virtual machine instruction processor and couples a small, embedded local processor 130 with a controller 132. The controller 132 is a local state machine and performs boot routine and interface functions. The seed processor 100 also includes a local memory, such as a random access memory (RAM) 112 for buffering of data and a read only memory (ROM) 114 for storing a TCP/IP stack. The seed processor 100 receives virtual machine instructions from a virtual machine 118 at a remote location to enable execution of software 116 local to the seed processor 100 without the size and cost burden of a co-located virtual machine. In an exemplary embodiment, the virtual machine instructions are Java virtual machine instructions. Each Java virtual machine instruction includes one or more bytes that encode instruction identifying information, operands, and any other required information.

The seed processor 100 communicates with a host processor 131 in the host 110. The embodiment shown in FIG. 1 illustrates a situation where the host 110 contains one seed processor 100 and one host processor 131. Host processors may be byte code processors, traditional RISC architecture or more conventional CISC architectures. However, it is possible for the host 110 to have other configurations such as multiple host processors 131 which are each connected to a single seed processor 100 or multiple host processors 131 with each host processor 131 connected to its own seed processor 100.

The embodiment shown in FIG. 1 illustrates that the virtual machine 118 sits, functionally, between a Java program 120 and the host 110, such that a remote host 122 supports the virtual machine 118 and the virtual machine 118 is not co-located with the seed processor 100. Thus, the virtual machine 118 is remote from the seed processor 100 and host 110. FIG. 1 illustrates a single remote host 122, however it is possible that the seed processor 100 can access a vast array of virtual machines 118 residing at any number of remote hosts 122. Thus, the seed processor 100 offers the program 116 the functionality of an “abstract computer” that executes the Java code and guarantees certain behaviors yet, places little burden on the physical system which runs the code.

The seed processor 100 is connected to a communication controller 124 located in the host 110. In one embodiment, the communication controller 124 communicates with a packet switched network 126 to receive virtual machine instructions for execution from a second communication controller 128 located in the remote host 122. The network 126 comprises an Internet-type of public, wide area computer network wherein data exchange is accomplished via Transmission Control Protocol/Internet Protocol (TCP/IP). Alternatively, network 126 may comprise an intranet or any or the various other types of public and/or private communications networks, including public or private telecommunications or telephone networks. The communication controllers 124 and 128 themselves can be implemented by a range of application specific techniques including high-speed Wide Area Network modems as would be found in hardwired set-top box applications, Wireless modems as would be found in mobile data and PDA applications, and specialized communications such as wireless cell phones, local and personal area networks and many others.

In one embodiment, the seed processor 100 includes the embedded local processor 130 which can be a microcontroller, a microprocessor or a byte-code processor such as the commercially available Ignite I from PTSC, the Acorn Risc Machine from ARM, or the A100 from Ajile. The local processor 130 in the seed processor 100 is dedicated to the seed processor 100. In an alternate embodiment, the seed processor 100 can use the host processor 131 which is resident in the host 110 as a processor. In this embodiment, the seed processor 100 does not have a dedicated processor, but the host processor 131 treats the seed processor 100 as a co-processor such that commands that require the virtual machine 118 are produced to the seed processor 100.

The virtual machine 118 receives requests to execute commands from the seed processor 100. When the request to execute the command is received, the virtual machine 118 is executed in the manner as is well known in the art. The virtual machine 118 then returns executable data over the network 126 to implement the operations on the local processor 130 or host processor 131. The executable data includes operations, byte-codes, classes and/or translations for the command.

The ROM 114 contained in the seed processor 100 executes a TCIP/IP stack and provides boot code. The seed processor 100 is provided an address of the virtual machine 118 in the remote host 122. These addresses can be hard coded, held in non-volatile memory such as ROM 114 or can be supplied by the host processor 131.

As stated above, the controller 132 is a state machine that controls the boot process, the interfaces of data between RAM 112 and ROM 114 and the sequential access of the remote virtual machine 118. Controller 132 can be implemented with hardware or software.

In one embodiment, the seed processor 100 provides greater enforcement of security policies, providing a secure remote limitation on what the Java program being executed can do. By providing a secure channel to a remote virtual machine 118, the security of Java can be enhanced by controlling not only the contents of the virtual machine 118 but also the access sequence at execution time.

The seed processor 100 provides greater longevity of fielded Java based systems. The Java language is not static and is prone to execution errors associated with new virtual machine instructions and the wide variety of virtual machines, which are in use. The seed processor 100 can be updated continuously simply by providing the updates to the remote virtual machine 118, allowing the entire installed base to execute new commands and new translations.

The RAM 112 in the seed processor 100 contains a local memory instruction cache 134 and an instruction buffer 136. In one embodiment, the seed processor 100 includes a control structure and an I/O bus (not shown) that accesses virtual machine information from the remote host 122 through the communication controller 124. The seed processor 100 loads the requested instruction into the instruction cache 134 and continues processing until there are no further instructions remaining or another virtual machine instruction which is not in the local instruction cache 134 is required.

A virtual machine instruction is loaded into the instruction buffer 136 from the instruction cache 134. The instruction can be loaded on any byte boundary of the instruction buffer 136. The processor 130 then uses the partial byte-codes held in the instruction cache 134 to execute the command or looks to the remote virtual machine 118 for byte-codes or translation codes to pull to its instruction cache 134 for cached execution.

No instruction decode unit is required in this system as the data that is accessed remotely indicates to the instruction cache 134 where to load the next virtual machine instruction in the instruction buffer 136. Since the remote virtual machine 118 is independent of the local processor 130 or the host processor 131, the Java commands, which are essentially index commands to the virtual machine 118, can be translated at the remote virtual machine 118, allowing the virtual machine 118 to return executable processor code which is ideally suited to the host processor 131 associated with the seed processor 100.

In environments in which the expense of the memory required for a software virtual machine instruction interpreter, classes and even system classes is prohibitive, the seed processor 100 of this invention is advantageous. The RAM 112 required to operate the seed processor 100 can be reduced to preferably about 32 Kilobytes (Kbytes), more preferably to about 16 Kbytes, and more preferably to between 4-8 Kbytes. The ROM 114 required to operate the seed processor 100 can be reduced to preferably about 128 Kbytes, more preferably to about 64 Kbytes, and more preferably to about 32 Kbytes.

Process Flow

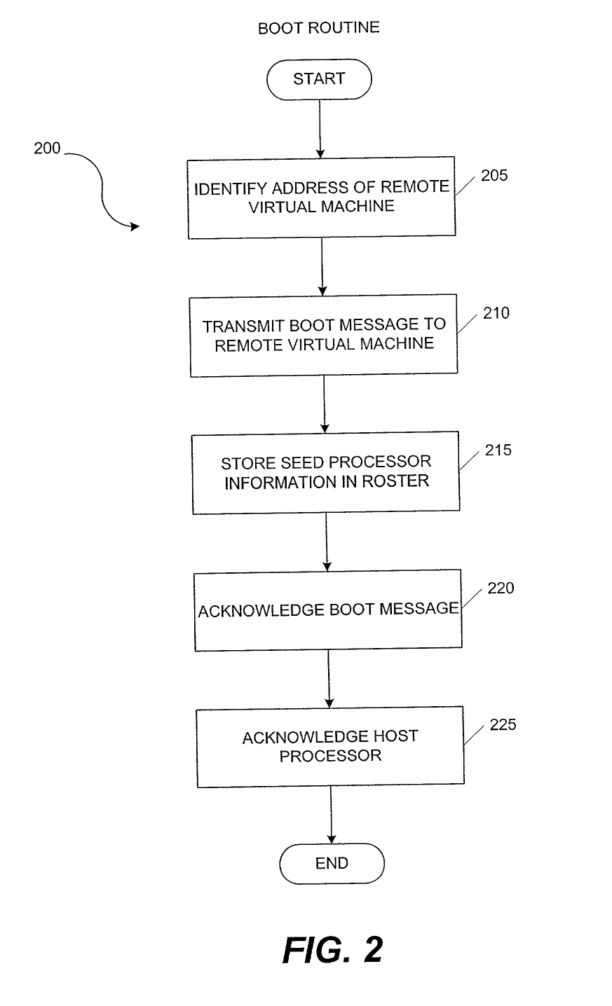

FIG. 2 is a flowchart illustrating an embodiment of a boot routine process 200 for the seed processor of FIG. 1. Depending on the embodiment, selected steps may be removed, others added, and the ordering of the steps may be rearranged. Starting at step 205, the address of the remote virtual machine 118 is identified. The address can be hard coded, held in non-volatile memory or can be supplied by a host processor. The act of identifying the address includes providing a fallback address of alternate virtual machines 118 in other remote hosts 122 if the virtual machine 118 in the remote host 122 is busy or not hosting upon attempting to establish a connection. The seed processor 100 can update the address such that an alternate remote host 122 can be designated as the primary source of the virtual machine 118.

Moving to step 210, a boot message is transmitted to the remote virtual machine. The seed processor 100 can transmit the message when powered up, or alternately, can wait until a particular request is received from the host 110 or host processor 131 that requires communication with the remote virtual machine 118. Waiting to establish the connection with the remote virtual machine 118 increases the time it takes to receive virtual machine instructions from the remote virtual machine 118 in the remote host 122, but is desirable in embodiments where power and resources are limited. Moving to step 215, the seed processor information is stored in a roster by the remote virtual machine. The roster aids the remote virtual machine 118 in identifying the number of seed processors 100 connected to the remote virtual machine 118. Proceeding to step 220, the remote virtual machine 118 acknowledges the boot message from the seed processor 100 by sending a message back to the seed processor 100. Moving to step 225, the host processor is acknowledged.

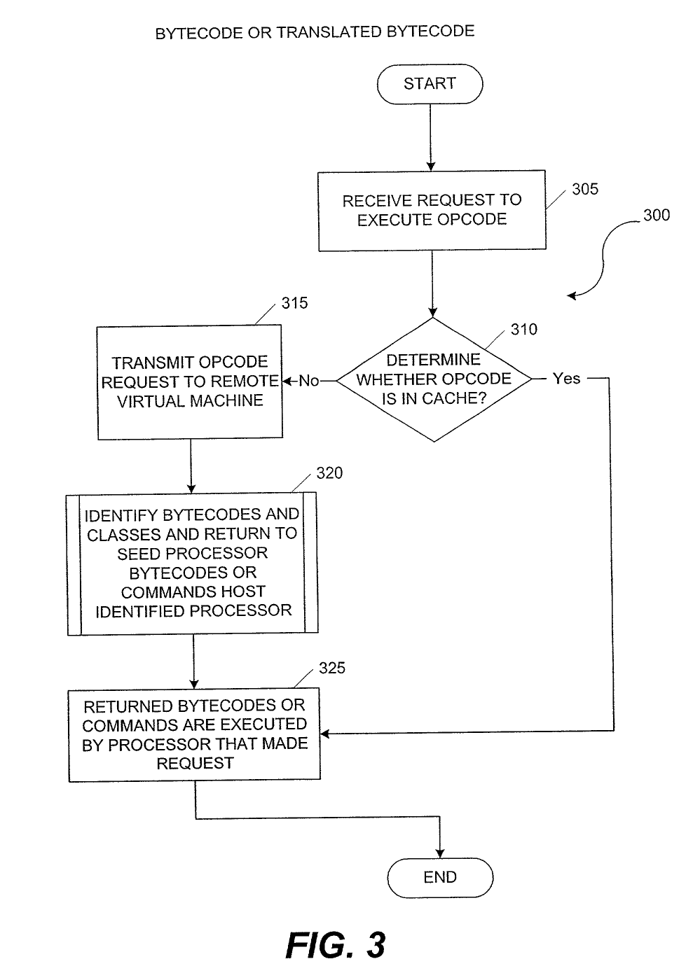

FIG. 3 is a flowchart illustrating a process 300 of executing commands at the host 110 using the seed processor 100 and the remote virtual machine 118. In one embodiment, the command can be Java opcode. Depending on the embodiment, selected steps may be removed, others added, and the ordering of the steps may be rearranged. Starting at step 305, the seed processor receives a request to execute a command from the host processor 131. The command can be Java or non Java code. Moving to step 310, the seed processor 100 determines if data required for execution of the command is stored in the locally accessible instruction cache 134.

If the data required for execution is not stored in the locally accessible instruction cache 134, the process moves to step 315 wherein the seed processor transmits a request to the remote virtual machine 118. As explained above, the request is transmitted over a packet switched network 126, such as the Internet, through communication controllers 124 and 128. In one embodiment, the request can be a Java command. Moving to step 320, the remote virtual machine 118 identifies the byte-codes and classes necessary for execution of the command and returns to the seed processor 100 the executable data for the processor that made the request. The executable data includes operations, byte-codes, classes, commands and/or translations for the command. The processor that made the request is the local processor 130 in embodiments where the seed processor includes an embedded local processor. In embodiments in which host processor 131 treats the seed processor 100 as a co-processor, the executable data would be returned to the host processor 131. Moving to step 325, the returned executable data are executed by the processor that made the request.

If at step 310 the process determines that the data required for execution is stored in the locally accessible instruction cache 134, the process moves to step 325 and the processor that made the request executes the command.

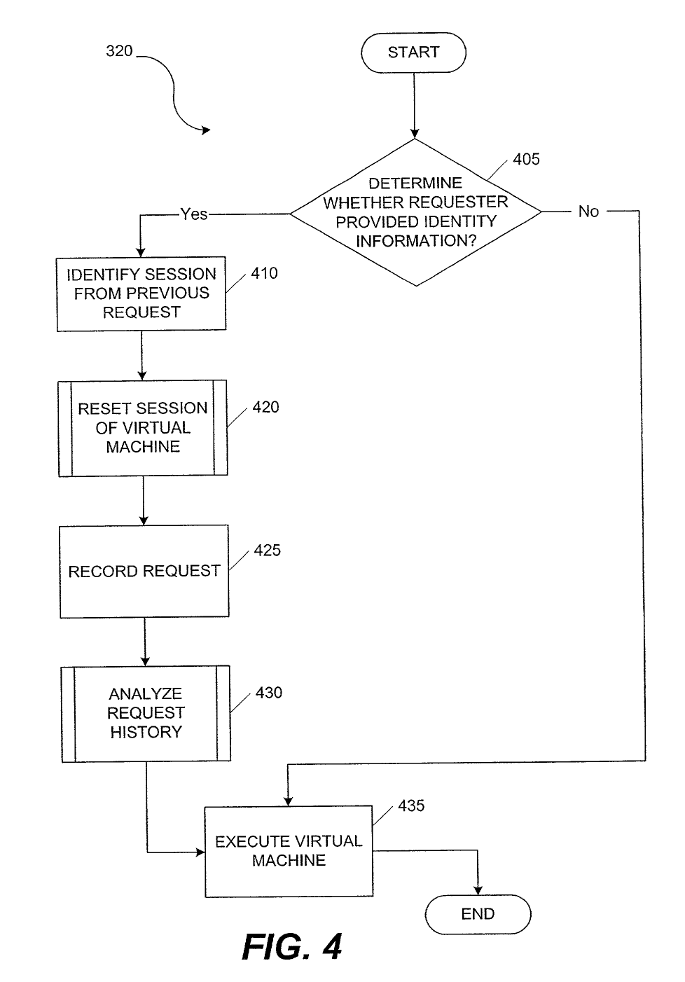

FIG. 4 is a flowchart illustrating the process of identifying byte-codes and classes and returning to the processor that made the request byte-codes or commands for the identified processor. FIG. 4 shows in further detail the steps that occur in step 320 of FIG. 3. Depending on the embodiment, selected steps may be removed, others added, and the ordering of the steps may be rearranged. Starting at step 405, the process determines whether the requester has provided identity information of the processor making the request. If the remote virtual machine 118 determines what type of processor is making the request, the virtual machine can determine in what form to send the response back to the processor making the request. An index can be used to correlate the identified type of processor to the translation required for that type of processor. Alternately, an address can be specified to receive requests from particular types of processors, such as an ARM processor, and the virtual machine 118 at the address always translates the opcode for the predetermined type of processor.

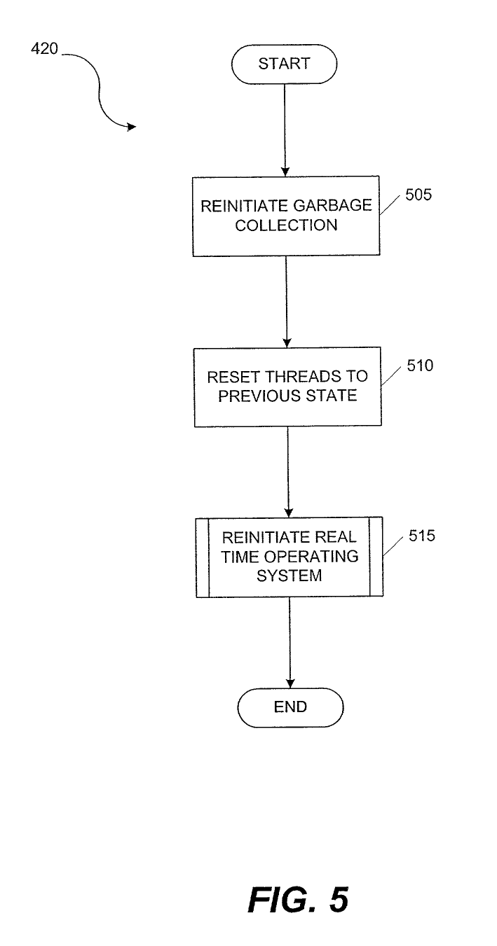

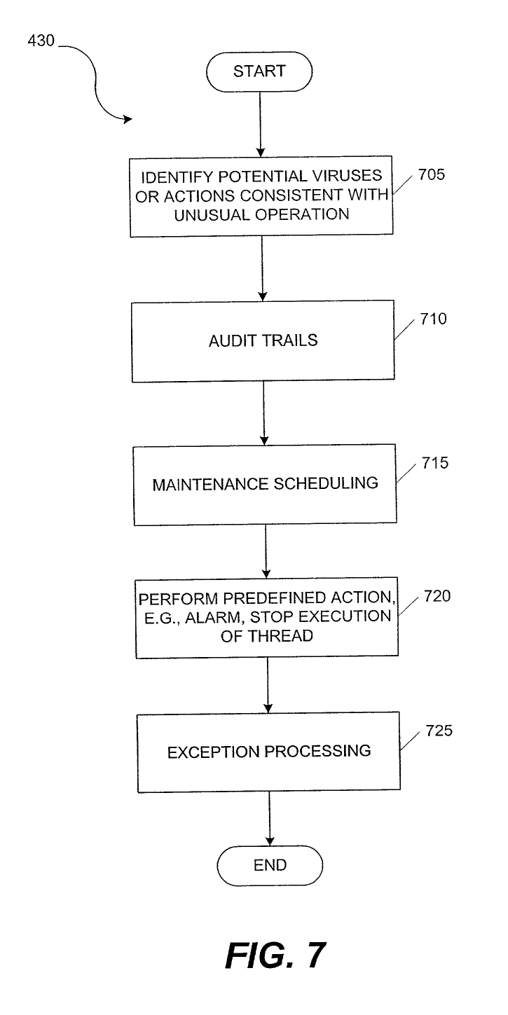

If identity information is provided, the process moves to step 410. At step 410, the process identifies if there is an open session from a previous request from the seed processor 100 to the virtual machine 118. The virtual machine 118 can pull up data specific to the seed processor 100 making the request based on prior requests from the seed processor. If a thread has previously been opened for the seed processor 100 and never closed, the virtual machine 118 can return to that thread. Moving to step 420, the process resets the session of the virtual machine. More detail for this step which will be described hereafter with reference to FIG. 5. Proceeding to step 425, the request is recorded and stored in a memory. Next, in step 430, the request history is analyzed as will be discussed below with reference to FIG. 7. Moving to step 435, the virtual machine is executed in a manner that is known in the art. If identity information is not provided at step 405, the process moves to step 435 and the virtual machine is executed.

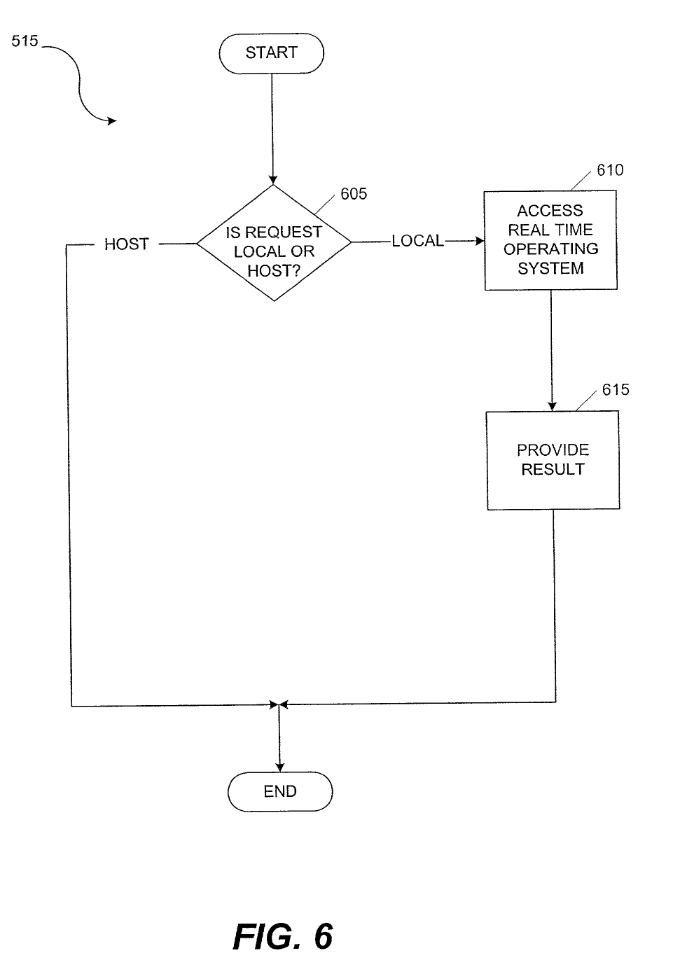

FIG. 5 is a flowchart that illustrates the process of resetting the session of the virtual machine. FIG. 5 shows in further detail the steps that occur in step 420 of FIG. 4. Depending on the embodiment, selected steps may be removed, others added, and the ordering of the steps may be rearranged. Starting at step 505, garbage collection is reinitiated. Moving to step 510, the threads are reset to the previous state. Next, in step 515, the real time operating system is reinitiated as will be discussed in further detail below with reference to FIG. 6.

FIG. 6 is a flowchart that illustrates the process of reinitiating the real time operating system. FIG. 6 shows in further detail the steps that occur in step 515 of FIG. 5. Depending on the embodiment, selected steps may be removed, others added, and the ordering of the steps may be rearranged. Starting at step 605, the process determines if the request is from the local processor 130 or the host processor 131. If the request is from the local processor 130, the process moves to step 610 and accesses the real time operating system (RTOS). Access to the RTOS is dependent of application and may simply be a remote thread which is co-processed with the local RTOS running on the host. Moving to step 615, a result is provided to the requester of command execution.

FIG. 7 is a flowchart that illustrates the process of analyzing the request history. FIG. 7 shows in further detail the steps that occur in step 430 of FIG. 4. Depending on the embodiment, selected steps may be removed, others added, and the ordering of the steps may be rearranged. Starting at step 705, potential viruses or actions consistent with unusual or viral operation are identified. Moving to step 710, an audit trail is created. Audit trials can be simple histories of data access or more complex predictive models of access profiles which project execution of questionable processes. Proceeding to step 715, maintenance scheduling is performed. Maintenance scheduling can include flags and alerts based on time, functions, operations or system level conditions and numerous other external conditions. Moving to step 720, a predetermined action is performed. The predetermined action can be triggering an alarm, terminating the execution of the thread or other action to draw attention to the identified condition as understood by one of ordinary skill in the art. Next, in step 725, the exception or unusual operation is processed.

Specific blocks, sections, devices, functions and modules have been set forth. However, a skilled technologist will recognize that there are many ways to partition the system of the present invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the system illustrated may be made by those skilled in the art, without departing from the intent of the invention.

What is claimed is:

1. A virtual machine instruction processor for executing commands using a remote virtual machine comprising:
a local memory cache for storing executable data for commands;
a local processor for executing virtual machine instructions, wherein the local processor is configured to search the local memory cache for executable data when a command is received and transmit a command request to a remote virtual machine if the executable data for the command are not found in the local memory cache; and
a controller for controlling the interface of data between the local processor, the local memory cache and the remote virtual machine.

2. The virtual machine instruction processor of claim 1, further including a read only memory (ROM) connected to processor for storing an address of a remote virtual machine.

3. The virtual machine instruction processor of claim 2, wherein the ROM comprises a TCIP/IP stack.

4. A host device containing a virtual machine instruction processor for executing instructions received from a remote virtual machine comprising:
a host processor;
a communication controller connected to a network for communicating with a remote virtual machine;
a virtual machine instruction processor connected to the host processor and the communication device, the virtual machine instruction processor comprising:
a local memory cache for storing executable data for commands;
a local processor for executing virtual machine instructions, wherein the local processor is configured to search the local memory cache for executable data when a command is received and transmit a command request to a remote virtual machine if the executable data for the command are not found in the local memory cache; and
a controller for controlling the interface of data between the local processor, the local memory cache and the remote virtual machine..

5. The host device of claim 4 further comprising a plurality of host processors wherein the virtual machine instruction processor is connected to each of the plurality of host processors.

6. The host device of claim 4 further comprising a plurality of virtual machine instruction processors and a plurality of host processors, wherein each of the plurality of host processor is connected to a different one of the plurality of virtual machine instruction processors.

7. The host device of claim 4, wherein the local processor is the host processor and the host processor treats the virtual machine instruction processor as a co-processor.

8. A system for communicating instructions over a network from a remote virtual machine to a host processor with a virtual machine instruction processor, the system comprising:
a network;
a remote device comprising:
a communication controller connected to the network;
a virtual machine.
a host device not co-located with the remote device comprising:
a host processor;
a communication controller connected to the network for communicating with the remote device; and
a virtual machine instruction processor connected to the host processor comprising a local memory cache for storing executable data for commands, a local processor for executing virtual machine instructions, wherein the local processor is configured to search the local memory cache for executable data when a command is received and transmit a command request to a remote virtual machine if the executable data for the command are not found in the local memory cache, and a controller for controlling the interface of data between the local processor, the local memory cache and the remote virtual machine.

9. The system of claim 8 wherein the network is the Internet.

10. The system of claim 8 wherein the virtual machine is a Java virtual machine.

11. The system of claim 10 wherein the virtual machine instruction processor transmits command requests to the remote virtual machine.

12. The system of claim 8, wherein the virtual machine determines the identity of the virtual machine instruction processor from the request.

13. The system of claim 8, wherein the virtual machine is configured to analyze a history of requests from the virtual machine instruction processor.

14. A server for communicating instructions over a network from a virtual machine to a host processor with a virtual machine instruction processor, the server comprising:
a communication controller connected to a network;
a virtual machine configured to receive virtual language commands from a remote virtual machine instruction processor, and identify byte-codes to the remote virtual machine through the communication controller.

15. The server of claim 14, wherein the virtual machine determines the identity of the virtual machine instruction processor from the request.

16. The server of claim 14, wherein the virtual machine is configured to analyze a history of requests from the virtual machine instruction processor.

17. The server of claim 14, wherein the virtual machine is a Java virtual machine.

18. A method of communicating commands over a network from a remote virtual machine to a host processor using a virtual machine instruction processor, the method comprising:
receiving a command from the host processor;
determining whether data required to execute the command is stored in a local memory accessible to the virtual machine instruction processor;
transmitting the command from the virtual machine instruction processor to the remote virtual machine if data to execute the command is not stored in the local memory;
executing the remote virtual machine to obtain executable data required to execute the command request;
returning executable data to the virtual machine instruction processor from the remote virtual machine; and
executing the executable data by the virtual machine instruction processor.

19. The method of claim 18, wherein returning executable data further includes storing the executable data in the local memory.

20. The method of claim 18, wherein the executable data comprises operations, byte-codes, classes and/or translations for the command.

21. The method of claim 18, wherein the virtual machine is a Java virtual machine.

22. The method of claim 18, wherein transmitting the command to the remote virtual machine includes transmitting the command over the Internet.

23. The method of claim 18, wherein executing the remote virtual machine further includes identifying the identity of the virtual machine instruction processor that transmitted the request.

24. The method of claim 18, further including analyzing a history of requests transmitted from the virtual machine instruction processor.

25. A virtual machine instruction processor embedded in a host device comprising a host processor for executing instructions received from a remote virtual machine comprising:
means for receiving a request by the virtual machine instruction processor from the host processor to execute a command;
means for determining whether the executable data required by the command is stored in a local memory accessible to the virtual machine instruction processor;
means for transmitting the command from the virtual machine instruction processor to the remote virtual machine if the executable data for the command is not stored in the local memory;
means for operating a remote virtual machine to obtain executable data;
means for returning the executable data to the virtual machine instruction processor from the remote virtual machine; and
means for executing the commands by the virtual machine instruction processor using the executable data.

26. The virtual machine instruction processor of claim 25, wherein the virtual machine is a Java virtual machine.

27. The virtual machine instruction processor of claim 25, wherein the command request is transmitted over a network.

28. A method of communicating instructions over the Internet between a remote Java virtual machine and a host processor using a virtual machine instruction processor, the method comprising:
receiving a command from the host processor;
determining whether the executable data for the command is stored in a local memory cache of the virtual machine instruction processor;
transmitting a command request from the virtual machine instruction processor to the remote Java virtual machine over the Internet if the executable data for the command is not stored in the local memory cache;
identifying the identity of the remote virtual machine instruction processor transmitting the command request;
identifying executable data for the command request at the remote virtual machine;
transmitting the executable data to the virtual machine instruction processor from the remote virtual machine, wherein the executable data returned is based at least in part on the type of processor that transmitted the command request; and
executing the executable data by the virtual machine instruction processor.

29. The method of claim 28, wherein the executable data comprises operations, byte-codes, classes and/or translations for the command.
